(19) United States
(12) Patent Application Publication
(10) Pub. No.: US 2025/0075376 A1
(43) Pub. Date: Mar. 6, 2025

(54) PROCESS FOR PREPARING A CARBON FIBER PRECURSOR

(71) Applicant: Leander F. AULISIO, Lakeland, FL (US)

(72) Inventor: Leander F. AULISIO, Lakeland, FL (US)

(21) Appl. No.: 18/038,625

(22) PCT Filed: Apr. 24, 2023
(86) PCT No.: PCT/US2023/019578

§ 371 Date: May 24, 2023

Related U.S. Application Data
(60) Provisional application No. 63/450,233, filed on Mar. 6, 2023.

(30) Foreign Application Priority Data
Mar. 6, 2023 (US) 63/450233

(51) Int. Cl. D01F 6/18; C08F 220/46; D01D 5/04; D01F 9/22; D06H 3/00

(52) U.S. Cl. CPC D01F 6/18; C08F 220/46; D01D 5/04; D06H 3/00; C08F 2800/20; D01F 9/22; D10B 2321/10

(57) ABSTRACT

A process for preparing a carbon fiber precursor wherein the precursor is selected from a series of solid PAN (polyacrylonitrile) fibers, wherein each member of the series contains about 2 weight % to about 8 weight % completely neutralized itaconic acid.

### BACKGROUND OF THE INVENTION

A process for preparing a carbon fiber precursor is hereby disclosed. U.S. Pat. No. 10,745,828 (Wilkinson), hereinafter referred to as the “Wilkinson Process”, is based on the discovery that the real “initiators” in the preparation of carbon fiber are the amidine bonds that are formed as cross-linkers in the PAN (polyacrylonitrile) fiber during the first heating step. The '828 patent is hereby included as by reference.

Prior to the Wilkinson Process, the first heating step, also called the densification step or the oxidation step, is at least three or four hours in length. This is because the internal temperature of the PAN fiber rises too quickly unless the heating is controlled by a series of increases and reductions over an extended period of time.

Before Wilkinson, the PAN fiber does not begin to form cross-links until the “fusion point” of the fiber is almost reached. Once the “fusion point” is reached, the internal temperature of the fiber quickly shoots up to a temperature of about 400 degrees C. and even higher, thus destroying the fiber (burnout).

The Wilkinson Process avoids this situation by allowing the PAN fiber to begin forming both internal (within a particular polymer segment) and external (between two or more polymer segments) cross-links soon after the densification step begins. The cross-links exhibit the structure of an amidine moiety. This structure is formed when ammonium nitrogen or quaternary ammonium nitrogen attacks a pendant cyano group on the PAN polymer.

In the Wilkinson Process, the cross-linking activity, resulting in densification of the fiber, begins rather quickly as the heating reaches about 180 degrees C. Cross-linking starts well before the “fusion point” of the fiber is reached. The density of the fiber goes from about 1.14 grams/cc. to about 1.4 grams/cc at the conclusion of the first heating step. Any possibility of “burn out” is avoided.

The Wilkinson Process begins by adding about 2 weight % to about 8 weight % itaconic acid monomer to the acrylonitrile monomer before polymerization. After polymerization is complete, a spin dope of PAN material is prepared and the spin dope is conducted to a wet spinning zone for preparation of filaments. The filaments are not immediately solidified, but rather are retained in the gel state.

Gelled filaments are imbibed with ammonia, an inorganic ammonium base or an organic base selected from the group consisting of a low molecular weight primary amine or a low molecular weight secondary amine. The neutralization reaction takes place in an aqueous bath of the selected base, preferably ammonia. The filaments remain in the gel state when contacting the aqueous bath. After contact with the aqueous ammonia bath, the polymer filaments undergo solvent extraction and drawing to give a solid filament. Filaments are then collected and bundled to yield a solid PAN fiber.

An advantage of the Wilkinson Process is that the first heating step in the carbonization process, the densification of the solid PAN fiber, is reduced from three or four hours to about thirty minutes or less. A second advantage of the Wilkinson Process is that there is little or no “waste” carbon fiber being produced due to “burn out”.

A journal article by Ge et al entitled “Texture and Properties of Acrylonitrile—Ammonium Itaconate Copolymer Precursor Fibers and Carbon Fibers” (Journal of Polymer Research, 2007, 14: pp. 91-97) discloses the preparation of carbon fiber from a monomer mixture of acrylonitrile and the bis ammonium salt of itaconic acid. The bis ammonium salt, which is a completely neutralized itaconic acid, is present in the mixture in an amount of 2 weight %, and the acrylonitrile is present in the mixture in an amount of 98 weight %. The authors found that PAN fiber containing an amount of completely neutralized itaconic acid results in a better precursor fiber than a precursor fiber containing itaconic acid.

A journal article by Chuansheng et al entitled “Acrylonitrile/ammonium itaconate aqueous deposited copolymerization” (Journal of Applied Polymer Science, vol. 102, Issue 1, Oct. 5, 2006, pp. 904-908) discloses the preparation of carbon fiber from a monomer mixture of acrylonitrile and the bis ammonium salt of itaconic acid. See Table 1, where the monomer ratio is 95 weight % acrylonitrile to 5 weight % bis ammonium salt of itaconic acid. The authors found that PAN fiber containing an amount of completely neutralized itaconic acid results in a better precursor fiber than PAN containing an amount of itaconic acid.

Both the Ge et al article and the Chuansheng et al article prove that, as Wilkinson had predicted, the presence of ammonium cation in the polymer material is essential for obtaining a carbon fiber precursor that can be readily densified. This is because the real initiators in the process of preparing superior carbon fiber are the amidine moieties formed during the initial heating step.

The presence of ammonium nitrogen or quaternary ammonium nitrogen in the solid PAN fiber is essential for the ability of the fiber to be densified quickly. This densification takes place during the initial heating step of the process. The PAN fiber containing completely neutralized itaconic acid can be employed as a carbon fiber precursor.

### SUMMARY OF THE INVENTION

In an embodiment, the present disclosure relates to a carbon fiber precursor prepared from a unique process for determining the best precursor for making carbon fiber. In another embodiment, the present disclosure relates to a process for making carbon fiber. In yet another embodiment, the present disclosure relates to an apparatus for making carbon fiber. In still another embodiment, the present disclosure relates to a carbon fiber prepared according to the presently disclosed process. In another embodiment, the present disclosure relates to a mixture of two monomers useful in the preparation of carbon fiber, the two monomers being acrylonitrile and completely neutralized itaconic acid.

The process of the present disclosure includes the steps of obtaining an itaconic acid monomer, completely neutralizing the monomer with a base to obtain a bis ammonium salt or a bis quaternary ammonium salt of the itaconic acid, and then purifying the completely neutralized itaconic acid.

The base is selected from the group consisting of ammonia, an inorganic ammonium base, and a low molecular weight primary amine and a low molecular weight secondary amine. Preferably the ammonium base is ammonium hydroxide. Both the primary amine and the secondary amine contain aliphatic hydrocarbon groups of from one to six carbon atoms.

Since itaconic acid is a dicarboxylic acid, the base must be present in an amount of at least about two moles of base per one mole of acid. In a preferred embodiment, the base is ammonium hydroxide and the product is a bis ammonium salt of itaconic acid.

A PAN (polyacrylonitrile) polymer is then prepared from acrylonitrile monomer and completely neutralized itaconic acid monomer. Following purification of the polymer, a spin dope of the polymer is prepared. The spin dope is spun through a die plate to obtain gelled filaments of PAN fiber. The filaments are solidified, gathered and bundled into a PAN fiber, which is then washed and stretched to obtain a carbon fiber precursor. The PAN fiber can contain from about one thousand filaments up to about fifty thousand filaments.

The PAN fiber is analyzed for physical properties such as: number of surface defects (the lower number of defects the better), interior homogeneity (the more homogeneous the better), degree of orientation (the higher degree of orientation the better), tenacity (the higher tenacity the better), number and size of microvoids (the smaller number and the smaller size of microvoids the better), arrangement of crystallites on the surface (homogeneous arrangement is better) and compactness of structure (the more compact the better).

In an embodiment, other PAN fibers are prepared from acrylonitrile monomer and completely neutralized itaconic acid monomer in specific ratios. These other PAN fibers are then analyzed for physical properties in the same manner as recited above.

After analysis of all the PAN fibers is complete, the fibers are ranked based on best combination of qualities. The highest ranked PAN fiber is then retained for densification and carbonization to obtain a carbon fiber.

In an embodiment, the densification step, unlike prior art processes, is conducted in the absence of oxygen. An inert gas such as nitrogen or argon can be employed. As is practiced in the art, an inert gas atmosphere is provided for the carbonization step.

### BRIEF DESCRIPTION OF THE DRAWINGS

FIG. 1 is a flow diagram showing a process for preparing a carbon fiber according to the present disclosure.

### DETAILED DESCRIPTION OF THE INVENTION

A neutralized itaconic acid monomer solution is prepared by adding the neutralizer base to a reactor charged with deionized water and itaconic acid. Such a method is disclosed in U.S. Pat. No. 5,223,592 (Hughes et al). The '592 patent is incorporated herein by reference. The process of the '592 patent is carried out by charging a reactor containing water with itaconic acid monomer. The reactor is heated, followed by the gradual addition, at substantially uniform addition rates, of a basic solution. The base must be present in an amount of at least two moles of base to one mole of itaconic acid.

The neutralization reaction is complete in less than about one hour. In a variation of the process, the basic solution and the itaconic acid monomer solution are added at substantially uniform addition rates. Since the addition of the base results in an exothermic reaction, the neutralizer base should be added slowly to the reactor, or the reactor may be cooled with ice while slowly adding the neutralizer. The resulting monomer solution is completely neutralized.

In an embodiment, the neutralization reaction can be performed by injection of ammonia gas into an organic solution containing itaconic acid. Such a method is disclosed in the Ge et al. article, incorporated herein by reference.

In the present disclosure, a completely neutralized itaconic acid monomer is purified and added to a polymerization unit along with acrylonitrile monomer. In an embodiment, the amount of completely neutralized itaconic acid monomer is about 2 weight % to about 8 weight %. The acrylonitrile monomer is present in an amount of about 92 weight % to about 98 weight %.

In a most preferred embodiment, the acrylonitrile monomer is present in the monomer mixture in an amount of about 95 weight % and the completely neutralized itaconic acid monomer is present in the mixture in an amount of about 5 weight %.

A restriction imposed on the present process is that a vinyl sulfonic acid monomer, allyl sulfonic acid monomer, salts thereof, and the like cannot be included in the feedstock composition. It has been observed that the presence of sulfonic acid groups in the final acrylonitrile copolymer causes retention of metal ions. Metal ions are deleterious to formation of the final carbon fiber product.

The feedstock for use in the present process must be substantially free of sulfonic acid groups. By substantially free of sulfonic acid groups is meant not more than 0.2 weight % sulfonic acid groups are present in the polymer composition.

Another restriction imposed on the present process is that a vinyl carboxylic acid, allyl carboxylic acid, or metal salts thereof and the like cannot be included in the feedstock composition.

In an embodiment, the completely neutralized itaconic acid can be substantially replaced with a neutralized vinyl carboxylic acid or a neutralized allyl carboxylic acid. Examples of vinyl carboxylic acids are acrylic acid, methacrylic acid and the like. If a neutralized vinyl carboxylic acid is employed, then the neutralized acid is present in the monomer mixture in an amount of about 4 weight % to about 16 weight %. Neutralization takes place in the presence of a nitrogen-containing base such as ammonia, ammonium hydroxide, a C₁-C₆ primary amine or a C₁-C₆ secondary amine.

In an embodiment, an ester of a vinyl carboxylic acid can be employed as a co-monomer. Examples are methyl acrylate, ethyl acrylate, methyl methacrylate, ethyl methacrylate and the like. Esters can be employed in the monomer mixture in an amount of about 1 weight % to about 2 weight %.

In an embodiment, the polymerization unit is a precipitation polymerization unit as disclosed in U.S. Pat. No. 5,364,581 (Wilkinson). The '581 patent is incorporated herein by reference. By precipitation polymerization is meant a polymerization process wherein the growing polymer comes out of solution at a certain stage, usually when about ten monomer units have been polymerized to form a polymer chain. Once out of solution, the polymer is unaffected by initiators and the like which tend to chain-stop the polymer. Monomer is able to penetrate the polymer and allows for the rapid continued growth of the polymer chain to a high molecular weight. Since the polymer growth is rapid, precipitation polymerization can be conducted in a continuous manner.

In an alternative embodiment, the polymerization reaction can be conducted in a batch reactor.

The solvent system used in the precipitation polymerization process can be a mixture of water and an organic solvent. The organic solvent must be capable of dissolving polyacrylonitrile co-polymer of a number average molecular weight of about 40,000 to about 100,000. In a preferred embodiment, the organic solvent is a member selected from the group consisting of dimethyl formamide, dimethyl acetamide, dimethyl sulfoxide, tetramethylene cyclic sulfone and butyrolactone. The organic solvent or mixtures of solvents can be present in the aqueous solvent system in an amount of from about 30% by volume to about 90% by volume.

It has been found that the polymerization rate of the co-monomers is dramatically increased when the water plus the solvent does not completely dissolve the co-polymer. In a preferred embodiment, a solvent system comprising dimethyl formamide (DMF) and water or dimethyl acetamide (DMAC) and water is employed.

Catalysts useful for the precipitation polymerization of acrylonitrile monomer and completely neutralized itaconic acid monomer are a peroxide and a low molecular weight volatile organic mercaptan. The organic mercaptan should have low volatility. The initiator system cannot contain any metal or metal ion containing compounds greater than about 10 ppm. The peroxide is hydrogen peroxide, t-butyl hydroperoxide, t-butyl per oxide and lauroyl peroxide or mixtures thereof. The mercaptan is a member selected from the group consisting of 1-thioglycerol, mercaptoethanol and butylmercaptan isomers. By butyl mercaptan isomers is meant normal butyl mercaptan, sec-butyl mercaptan and iso-butyl mercaptan. By low molecular weight organic mercaptan is meant a C₁-C₆ organic mercaptan.

A catalytic amount (about 10 ppm) of an iron compound is added to the mixture of solvent, initiator and monomer systems. Examples of iron catalysts are ferric (or ferrous) nitrate, ferric (or ferrous) chloride, and ferric (or ferrous) ammonium sulfate. The compounds can have water of hydration associated therewith.

A polyacrylonitrile can be prepared from a mixture of monomers. The monomers can be acrylonitrile and completely neutralized itaconic acid. Solvents and catalysts are employed under suitable conditions of temperature and pressure. In a preferred embodiment, the reaction is conducted at a temperature of about 50 C. to about 70° C.; and at a pressure of about 1.0 to about 1.2 atmospheres.

As the polymerization continues, feedstock, solvent and initiator can be added either in a continuous fashion or at regular intervals to maintain correct amounts of reactants and the like in accordance with parameters well-known to those skilled in the art. Preferably the polymerization is continued until the solids content reaches about 20% to about 40%. The precipitation polymerization provides for a rapid rate of conversion and a high molecular weight product.

The present process is best conducted in a continuous precipitation polymerization manner, which allows good dissipation of the heat of polymerization and allows reaction times as short as 30-60 minutes.

Once the polymerization is complete, the water and unreacted acrylonitrile and unreacted, completely neutralized itaconic acid are removed as by stripping, and the polyacrylonitrile polymer dissolves in the organic solvent. Additional organic solvent is added to adjust solids to the proper viscosity.

In an alternative embodiment, acrylonitrile and completely neutralized itaconic acid are co-polymerized in dimethyl sulfoxide (DMSO). A free radical solution polymerization is conducted in the presence of a radical initiator such as azobisisobutyronitrile (AIBN). A polyacrylonitrile (PAN) material is obtained.

The polyacrylonitrile material is then purified as by washing, drying and forming a powder. The powder is then slurried with organic solvent to produce a spin dope. In an embodiment, the organic solvent can be DMF or DMAC. The spin dope is extruded through a die plate to obtain fine filaments having a dernier of about 1 to about 8. In an embodiment, the die plate contains about 2100 holes, which provides for 2100 filaments.

Wet spinning of the material allows formation of filaments having a substantially circular cross-section. After wet spinning, the filaments are bundled into fibers and passed to a wash zone. Fibers are then washed to remove solvent and drawn over tensioning rollers.

In an embodiment, the fibers are optionally passed into a relaxation unit where they are relaxed to about 10%.

To prepare carbon fiber, the PAN fibers are passed first to a densification zone (oxidizing zone) and then to a carbonizing zone. The densification zone can be a single heating oven or a series of three heating rolls, each roll increasing in temperature in a step-wise fashion.

In an embodiment, the heating oven includes a cylindrical oven containing programmed heating coils which adjust in temperature in accordance with a predetermined heating cycle of increasing temperature. The cylindrical oven can be sealed to prevent addition of oxygen or air. An inert atmosphere of nitrogen or argon or the like can be maintained in the heating oven.

In an alternative embodiment, the series of three heating rolls includes a first heating roll maintained at a temperature of about 235 degrees C. to about 245 degrees C., a second heating roll maintained at a temperature of about 245 degrees C. to about 255 degrees C., and a third heating roll maintained at a temperature of about 255 degrees C. to about 265 degrees C. Densification of the polyacrylonitrile fiber begins on the first heating roll and continues until the end of the heating process. The fiber is removed from the third heating roll and passed to an uptake roll. The density of the fiber has increased from about 1.14 grams per cc to about 1.4 grams per cc. This densification is achieved in a short period of time, preferably about fifteen minutes to about thirty minutes.

The densified polyacrylonitrile fiber is then passed to a carbonization zone. In a matter of a few seconds or less the fiber is stripped of all atoms except carbon. The carbon fiber removed from the carbonization zone has excellent homogeneity and tensile strength. Very little, if any, “waste” carbon fiber is produced.

In an embodiment, a process for preparing a carbon fiber precursor is hereby disclosed. The process includes the steps of: obtaining an acrylonitrile monomer; obtaining a completely neutralized itaconic acid monomer; polymerizing the acrylonitrile monomer with the completely neutralized itaconic acid monomer in a polymerization reactor; and withdrawing the PAN carbon fiber precursor. The acrylonitrile monomer is present in an amount of about 92 weight % to about 98 weight %. The completely neutralized itaconic acid monomer is present in an amount of about 8 weight % to about 2 weight %. Preferably, the acrylonitrile monomer is present in an amount of about 95 weight % and the completely neutralized itaconic acid is present in an amount of about 5 weight %.

The completely neutralized itaconic acid monomer is neutralized with a base selected from the group consisting of ammonia, ammonium hydroxide, a low molecular weight primary amine and a low molecular weight secondary amine. Preferably, the base is ammonium hydroxide.

The polymerization reactor is a precipitation polymerization reactor. A batch reactor can also be employed, but it is not as desirable.

In a further embodiment, PAN fiber is heated in two steps to obtain a carbon fiber. The heating includes a densification step and a carbonization step. In the densification step, the temperatures can range from about 250 degrees C. to about 400 degrees C.

In prior art processes for preparing carbon fiber, oxygen (or air) is employed to initiate the necessary cross-linking of the PAN fiber. Cross-linking with oxygen results in non-homogeneous crosslinks, which ultimately damages the tensile strength of the fiber. In a preferred embodiment, densification of the carbon fiber precursor is performed in an inert atmosphere such as nitrogen or argon. In this atmosphere, all of the cross-linking occurs due to the presence of the ammonium salt.

In an embodiment, a densified PAN fiber, also called a PANOX (oxidized polyacrylonitrile) fiber, having a density of about 1.4 grams per cubic centimeter, can be carbonized in a carbonization zone in a few seconds or less to obtain a carbon fiber having superior homogeneity and tensile strength.

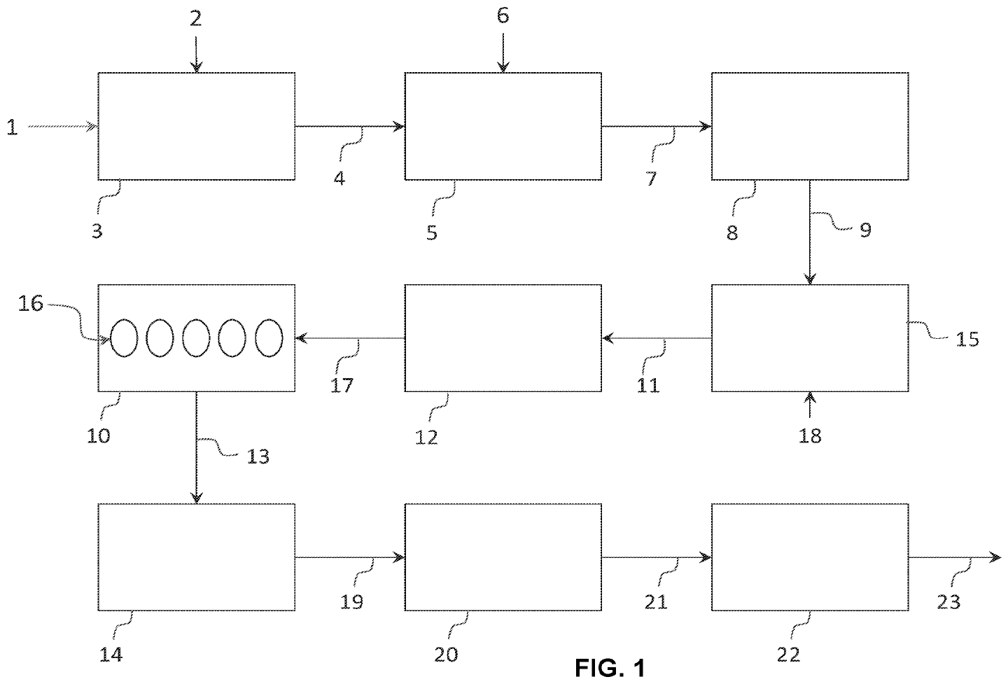

Referring to FIG. 1, a flow diagram of a process for preparing a carbon fiber according to the present disclosure is presented. Itaconic acid is added via first transport means 1 to a neutralization reactor 3. A basic compound such as ammonium hydroxide is then added in step-wise fashion to reactor 3 via a second transport means2. When the reaction is concluded, a completely neutralized itaconic acid is withdrawn from the reactor 3 and then added via a third transfer means 4 to a polymerization zone 5. Acrylonitrile monomer is added via a fourth transfer means 6 to polymerization zone 5. After a polymerization reaction is conducted, a PAN material is transferred to a first solvent extraction zone 8 via a fifth transfer means 7. A purified PAN material in solid form is withdrawn from the first solvent extraction zone 8 and is transferred via a sixth transfer means 9 to a spin dope preparation zone 15. The purified PAN is blended with a suitable solvent such as DMF (dimethyl formamide) or DMAC (dimethyl acetamide) via a seventh transfer means 18 to obtain a spin dope having a honey-like consistency.

The spin dope is transferred through an eighth transfer means 11 to a spinning zone 12. In an embodiment, the spinning zone 12 is a wet spinning zone. Wet spinning allows formation of filaments having substantially circular cross-sections. Dry spinning causes the filaments to have dog-bone shaped cross sections, which shape is not desirable for preparing PANOX fiber.

PAN filaments are removed from the spinning zone 12 and added to a bundling zone 10 via a ninth transfer means 17. Filaments are bundled together and a PAN fiber 16 is withdrawn from the bundling zone 10 and removed to a second solvent removal zone 14 by employing a tenth transfer means 13. The solvent removal zone also contains a drawing apparatus (not shown) for stretching the PAN fiber.

While immersed in the second solvent removal zone 14, the PAN fiber is drawn at least about 7× to set the physical properties of the fiber. Also, solvent is removed from the fiber. The drawn PAN fiber can then optionally be added to a relaxation zone (not shown), which can comprise a set of steamed rollers (not shown) in order to relax the drawn PAN fiber. The drawn fiber is relaxed at least about 8% to about 12%. Preferably, the PAN fiber is relaxed about 10% in the relaxation zone.

The relaxed PAN fiber is then removed to an analysis zone (not shown), where the fiber is measured for various physical properties. The PAN fiber is analyzed for physical properties such as: number of surface defects (the lower number of defects the better), interior homogeneity (the more homogeneous the better), degree of orientation (the higher degree of orientation the better), tenacity (the higher tenacity the better), number and size of microvoids (the smaller number and the smaller size of microvoids the better), arrangement of crystallites on the surface (homogeneous arrangement is better) and compactness of structure (the more compact the better).

In an embodiment, other PAN fibers are prepared from acrylonitrile monomer and completely neutralized itaconic acid monomer in specific ratios. Preferably, the ratios are from about 2 weight % completely neutralized itaconic acid to about 8 weight % completely neutralized itaconic acid. These other PAN fibers are then analyzed for physical properties in the same manner as recited above.

After analysis of all the PAN fibers is complete, the fibers are ranked in a ranking zone (not shown), based on best combination of physical properties. The highest ranked PAN fiber is then retained for densification and carbonization to obtain a carbon fiber.

In an embodiment, the highest ranked PAN fiber can be transferred to rolls and stored as a carbon fiber precursor which is ready to be shipped to customers for later densification and carbonization.

In an embodiment, the present disclosure relates to a PAN fiber useful as a carbon fiber precursor, said fiber prepared according to the process disclosed herein.

Selected PAN fiber (highest ranked) is then removed to a densification zone 20 via an eleventh transfer means 19. Within the densification zone 20, the density of the fiber increases from about 1.14 grams per cc. to about 1.41 grams per cc. The time of the densification reaction is reduced from about three hours to about thirty minutes or less. PANOX fiber is withdrawn from the densification zone 20.

This PANOX (oxidized polyacrylonitrile) fiber, although not the same as pristine carbon fiber, can be employed in many areas of technology.

In an embodiment, PANOX fiber is taken up on rolls and shipped to customers for carbonization in an oven that can reach about 1,000 degrees C. to about 4,000 degrees C.

If pristine carbon fiber is desired, PANOX fiber is removed as by a twelfth transfer means 21 to a carbonization zone 22 which contains an inert atmosphere such as argon gas or the like. The conversion temperature in the carbonization zone 22 is in the range of about 1000 degrees C. to about 2000 degrees C. or higher. The PANOX fiber is converted into carbon fiber. Carbon fiber is withdrawn from the carbonization zone 22 via thirteenth transfer means 23.

In an embodiment, the densification step takes place over a set of three rollers of sequentially higher temperatures. In an alternative embodiment, the densification step is conducted in a sealed cylindrical oven containing programmable heating coils. In another embodiment, the densification step can be conducted in the presence of an inert atmosphere. The inert gas can be nitrogen or argon or the like.

In an embodiment, the present disclosure relates to a carbon fiber having high tensile strength, wherein the carbon fiber is prepared according to the process disclosed herein below. The process includes the steps of: obtaining a series of PAN fibers, wherein each PAN fiber in the series includes an amount of completely neutralized itaconic acid, wherein the completely neutralized itaconic acid is present in the fiber in an amount of about 2 weight % to about 8 weight %, and wherein the itaconic acid is neutralized with a base selected from the group consisting of ammonia, ammonium hydroxide, a low molecular weight primary amine and a low molecular weight secondary amine.

An analysis of each PAN fiber in the series is performed in an analysis zone. The analysis includes: determining number of surface defects (a lower number of surface defects ranks higher), determining interior homogeneity (a more homogeneous situation ranks higher), determining degree of orientation (a higher degree of orientation ranks higher), determining tenacity (a greater tenacity ranks higher), determining number and size of micro voids (a smaller number and smaller size ranks higher), determining compactness of structure (a more compact structure ranks higher) and arrangement of crystallites on the surface (a more homogeneous arrangement ranks higher). The PAN fibers are then ranked in a ranking zone, the ranking based on combined qualities of each fiber.

The process further includes: obtaining the most highly ranked PAN fiber, removing the most highly ranked fiber to a densification zone and withdrawing from the densification zone a PANOX (oxidized polyacrylonitrile) fiber. The process then includes: removing the PANOX fiber to a carbonization zone and withdrawing the carbon fiber having high tensile strength.

The low molecular weight primary amine useful in neutralizing the itaconic acid monomer includes a C₁ to C₆ alkyl group, and the low molecular weight secondary amine includes two C₁ to C₆ alkyl groups. In an embodiment, the two alkyl groups on the secondary amine can be the same or different.

In an embodiment, the present disclosure relates to an apparatus for the preparation of carbon fiber. The apparatus includes: a neutralization reactor for preparing a completely neutralized itaconic acid monomer; a polymerization zone; a first solvent extraction zone; a spin dope preparation zone; and a spinning zone. The apparatus further includes: a bundling zone; a second solvent extraction zone; a densification zone; and a carbonization zone.

The apparatus also includes a first transfer means for transferring the itaconic acid to the neutralization zone; a second transfer means for addition of base to the neutralization zone; a third transfer means for addition of completely neutralized itaconic acid monomer to the polymerization zone; and a fourth transfer means for addition of acrylonitrile monomer to the polymerization zone.

The apparatus also contains a fifth transfer means for removing a polyacrylonitrile from the polymerization zone and adding the polymer to the first solvent extraction zone; a sixth transfer means for removing a purified polyacrylonitrile from the first solvent extraction zone and adding the purified polymer to the spin dope preparation zone; a seventh transfer means for adding a chemical which is a member selected from the group consisting of DMF and DMAC to the spin dope preparation zone; and an eighth transfer means for removing a spin dope from the spin dope preparation zone and adding said spin dope to the spinning zone. Furthermore, the apparatus includes a ninth transfer means for removing spun filaments from the spinning zone and adding said filaments to the bundling zone; a tenth transfer means for removing a PAN fiber from the bundling zone and transferring the fiber to the second solvent extraction zone; an eleventh transfer means for removing a purified PAN fiber from the second solvent extraction zone and transferring said purified fiber to the densification zone; a twelfth transfer means for removing a PANOX fiber from the densification zone and transferring to the carbonization zone; and a thirteenth transfer means for removing a carbon fiber from the carbonization zone.

The polymerization zone is preferably a precipitation polymerization zone. The spinning zone includes a die plate.

In an embodiment, the densification zone comprises a set of three rollers of sequentially higher temperatures. In an alternative embodiment, the densification zone comprises a sealed cylindrical oven containing programmable heating coils.

In an embodiment, the present disclosure relates to a precursor fiber useful for the preparation of carbon fiber of high tensile strength. The precursor fiber is obtained by a process including: preparing a series of monomer mixtures, wherein each of the monomer mixtures includes acrylonitrile and completely neutralized itaconic acid. An amount of completely neutralized itaconic acid monomers is found in the series, ranging from about 2 weight % to about 8 weight %.

The process includes completely neutralizing itaconic acid with a base. The base can be ammonia, ammonium hydroxide, a low molecular weight primary amine, a low molecular weight secondary amine or mixtures thereof.

Each monomer mixture of the series contains a specific ratio of acrylonitrile monomer to completely neutralized itaconic acid monomer. The ratios extend from about 2 weight % completely neutralized itaconic acid to about 8 weight % itaconic acid. Thus the acrylonitrile is present in an amount of about 98 weight % to about 92 weight %. In an embodiment, all other co-monomers are excluded from the mixture of monomers.

In a preferred embodiment, the number of monomer mixtures in the series can be four mixtures. The four monomer mixtures can be as follows: 2 weight % completely neutralized itaconic acid (98 weight % acrylonitrile), 4 weight % completely neutralized acid (96 weight % acrylonitrile), 6 weight % completely neutralized itaconic acid (94 weight % acrylonitrile), and 8 weight % completely neutralized itaconic acid (92 weight % acrylonitrile).

Each of the separate monomer mixtures is then polymerized in a polymerization unit to obtain a PAN material. In an embodiment, the PAN material is in the form of flakes or powder.

Each of the separate PAN materials is mixed with a suitable organic solvent to obtain a spin dope. Preferably, the solvents are dimethyl formamide (DMF), dimethyl acetamide (DMAC) or mixtures thereof.

Each of the spin dopes is removed to a spinning unit to obtain filaments in the gel state. The filaments are removed to a first solvent extraction zone and a tensioning zone. Solid filaments are then combined in a bundling zone to obtain a PAN fiber. This fiber can be further treated in a second solvent extraction zone, a stretching zone and a relaxation zone. In the present disclosure, this PAN fiber is called the “carbon fiber precursor”.

Each of the carbon fiber precursors is then removed to an analysis zone. The analysis zone includes analytic devices for measuring physical properties of the carbon fiber precursors.

Each of the carbon fiber precursors (PAN fibers) is then categorized and ranked based on comparison of the various physical properties. For example, a fiber having better aligned crystallites in the skin of the fiber ranks higher than a fiber that has less aligned crystallites. Also, a fiber that has a more homogeneous internal structure is ranked more highly than one which has a more heterogeneous internal structure.

The most highly ranked carbon fiber precursor (PAN fiber) is then conducted to a densification unit, where it is densified to obtain an oxidized PAN (PANOX) fiber. The PANOX fiber is then removed to a carbonization unit. A carbon fiber having a high tensile strength is then removed from the carbonization unit.

It is within the scope of the present disclosure to employ more than four monomer mixtures. It is possible to employ monomer mixtures that differ in only one unit of weight %. Thus a series of monomer mixtures can be those containing 2 weight %, 3 weight %, 4 weight % and so on up to 8 weight % of completely neutralized itaconic acid. Such a series allows for a more fine tuned approach for discovering a leading candidate for later densification and carbonization.

In an embodiment, the present disclosure relates to a monomer mixture useful in preparing the most highly ranked carbon fiber precursor (PAN fiber). A mixture of monomers useful in preparing a carbon fiber precursor is hereby disclosed. The mixture is selected from a series of monomer mixtures comprising acrylonitrile in an amount of about 92 weight % to about 98 weight % and completely neutralized itaconic acid in an amount of about 8 weight % to about 2 weight %. The itaconic acid is neutralized with a base. Preferably, the base is ammonia, ammonium hydroxide, a low molecular weight primary amine, a low molecular weight secondary amine or mixtures thereof. A series of solid PAN fibers is prepared from the series of monomer mixtures. The series of solid PAN fibers is analyzed for a physical property. The physical properties include: number of surface defects, interior homogeneity, degree of orientation, tenacity, number and size of micro voids, arrangement of crystallites on the surface, compactness of structure, or combinations thereof to obtain a series of analysis results. The series of solid PAN fibers is ranked based on the series of analysis results. The mixture of monomers yielding the most highly ranked solid PAN fiber is employed as a starting material for the preparation of the carbon fiber precursor.

In an embodiment, the present disclosure relates to a PAN polymer useful in preparing the most highly ranked carbon fiber precursor (PAN fiber).

In an embodiment, the present disclosure relates to a PAN fiber (carbon fiber precursor) useful in preparing the most highly ranked carbon fiber precursor (PAN fiber).

In an embodiment, the present disclosure relates to a PANOX fiber obtained from the most highly ranked carbon fiber precursor (PAN fiber).

In an embodiment, the present disclosure relates to a carbon fiber prepared from a PANOX fiber obtained from the most highly ranked carbon fiber precursor (solid PAN fiber).

In an embodiment, the present disclosure relates to an apparatus for preparing carbon fiber according to the process disclosed above.

In an embodiment, a process for preparing a carbon fiber precursor is hereby disclosed. The process includes the steps of: obtaining a series of monomer mixtures, individually polymerizing the series of monomer mixtures in a polymerization unit, individually withdrawing from the polymerization unit a series of polymers. The process further includes: individually forming spin dopes from the series of polymers, individually removing the spin dopes to a spinning unit and spinning each spin dope in the series. Further, the process includes: individually withdrawing from the spinning unit a series of gelled filaments, individually removing the series of gelled filaments to a first solvent extraction zone, and individually withdrawing from the first solvent extraction zone a series of filaments. The process further includes the steps of:

individually removing the series of filaments to a bundling zone; individually withdrawing from the bundling zone a series of fibers, individually removing the series of fibers to a second solvent extraction zone, and individually withdrawing from the second solvent extraction zone a series of fibers. The process also includes: individually removing the series of fibers to a stretching zone and relaxing zone, individually withdrawing from the stretching zone and relaxing zones a series of solid PAN fibers, and individually removing the series of solid PAN fibers to an analysis zone. The process further includes the steps of: individually analyzing the series of solid PAN fibers for a physical property which is a member selected from the group consisting of: number of surface defects, interior homogeneity, degree of orientation, tenacity, number and size of micro voids, arrangement of crystallites on the surface, compactness of structure, and combinations thereof to obtain a series of analysis results; and ranking the series of solid PAN fibers based on the series of analysis results. The process further includes: selecting the solid PAN fiber that is the most highly ranked as the carbon fiber precursor. The process includes removing the carbon fiber precursor to a series of heating zones to obtain a carbon fiber.

The series of monomer mixtures includes a mixture of acrylonitrile monomer and completely neutralized itaconic acid monomer. In an embodiment, the acrylonitrile monomer is present in an amount of about 92 weight % to about 98 weight %, and the completely neutralized itaconic acid monomer is present in an amount of about 2 weight % to about 8 weight %.

In an embodiment, a carbon fiber is prepared from a mixture of monomers. The specific mixture of monomers is obtained from a ranking of a series of solid PAN fibers. The solid PAN fibers are obtained from a series of monomer mixtures, wherein the series of monomer mixtures includes acrylonitrile in an amount of about 92 weight % to about 98 weight % and completely neutralized itaconic acid in an amount of about 2 weight % to about 8 weight %.

In an embodiment, carbon fiber is obtained from the most highly ranked series of monomers, wherein the series of monomers are the starting materials for preparing the series of solid PAN fibers employed in the ranking step. Ranking is based on physical properties selected from: number of surface defects, interior homogeneity, degree of orientation, tenacity, number and size of micro voids, arrangement of crystallites on the surface, and compactness of structure. Preferably, all of the physical properties listed above are employed in ranking the series of solid PAN fibers.

In an embodiment, the present disclosure relates to an apparatus for preparing a carbon fiber precursor. The apparatus includes: a neutralization zone for obtaining a completely neutralized itaconic acid. A neutralizing agent can be ammonia, ammonium hydroxide, a C₁-C₆ alkyl primary amine and a C₁-C₆ dialkyl secondary amine. The apparatus further includes: a polymerization zone for obtaining a solid PAN polymer. The polymerization zone includes a polymerization reactor charged with acrylonitrile monomer and completely neutralized itaconic acid monomer. A first transfer means is provided for removing the completely neutralized itaconic acid to the polymerization zone. The apparatus further includes: a spin dope preparation zone for addition of an organic solvent to the PAN polymer to obtain a spin dope; a second transfer means for removing the PAN polymer to the spin dope preparation zone; a spinning zone for obtaining a gelled PAN filament; and a third transfer means for removing the spin dope to the spinning zone.

The apparatus includes: a solvent removal zone for solidifying the gelled PAN filament to obtain a solid PAN filament; a fourth transfer means for removing the gelled PAN filament to the solvent removal zone; a stretching zone for obtaining an elongated solid PAN filament; and a fifth transfer means for removing the solid PAN filament to the stretching zone. The apparatus further includes: a relaxation zone for obtaining a relaxed elongated solid PAN filament; a sixth transfer means for removing the elongated solid PAN filament to the relaxation zone; a bundling zone for obtaining a solid PAN fiber from a collection of relaxed elongated solid PAN filaments; and a seventh transfer means for removing the relaxed elongated solid PAN filament to the bundling zone.

In an embodiment, the apparatus further includes: an analysis zone for obtaining an analyzed solid PAN fiber. The analysis zone includes measurement devices for obtaining a physical property of the solid PAN fiber. The physical properties include: number of surface defects, interior homogeneity, degree of orientation, tenacity, number and size of micro-voids, arrangement of crystallites on the surface of the fiber, compactness of structure and combinations thereof. The apparatus includes: an eighth transfer means for removing the solid PAN fiber to the analysis zone; a ranking zone for obtaining a ranked solid PAN fiber; and a ninth transfer means for removing the analyzed solid PAN fiber to the ranking zone.

In an embodiment, a mixture of monomers useful in preparing a carbon fiber precursor is disclosed. The mixture is selected from a series of monomer mixtures comprising acrylonitrile in an amount of about 92 weight % to about 98 weight % and completely neutralized itaconic acid in an amount of about 8 weight % to about 2 weight %;. The itaconic acid is neutralized with a base selected from the group consisting of ammonia, ammonium hydroxide, a low molecular weight primary amine, a low molecular weight secondary amine and mixtures thereof. A series of solid PAN fibers is prepared from the series of monomer mixtures. The series of solid PAN fibers is then analyzed for a physical property. The physical property can be: number of surface defects, interior homogeneity, degree of orientation, tenacity, number and size of micro voids, arrangement of crystallites on the surface, compactness of structure. Combinations of the physical properties are preferred. In a most preferred embodiment, analysis of all of the physical properties listed above is conducted on each solid PAN fiber in the series.

A series of analysis results is obtained, and the series of solid PAN fibers is ranked based on the series of analysis results. The mixture of monomers yielding the most highly ranked solid PAN fiber is employed as the carbon fiber precursor.

In an embodiment, the number of monomer mixtures in the series is two monomer mixtures, three monomer mixtures, four monomer mixtures, five monomer mixtures, six monomer mixtures, seven monomer mixtures or eight monomer mixtures. It is within the scope of the invention to employ more than eight monomer mixtures.

### Example

A jacketed aluminum reactor is charged with a solvent mixture of dimethyl formamide (DMF) and water in a ratio of about 80:20 by volume and in an amount of 0.6 liters. An acrylonitrile monomer and a completely neutralized itaconic acid monomer are added to the reactor in a weight ratio of 95:5 and in an amount of 400 grams. Ammonium hydroxide base is employed to completely neutralize the itaconic acid monomer prior to addition to the reactor.

Hydrogen peroxide catalyst in an amount of about 0.5% based on total monomer weight is then added to the reactor. 1-Thioglycerol is added to the reactor in an amount of about 0.3% based on total monomer weight. Ferrous Ammonium Sulfate Hydrate is added to the reactor in an amount of about 10 ppm based on total reagents.

The precipitation polymerization is conducted in the aluminum reactor at a temperature of about 30 degrees C. to about 50 C. and a pressure of about 1.0 atmospheres. Polymerization is continued until the solids content reaches about 25% to 30% solids (about 1 hour). After polymerization is complete, a vacuum stripping system is employed to remove water and unreacted monomers. The stripping operation yields a direct spin dope without isolation of polymer. To reduce the solids to 30%, add 220 grams of DMF.

While the invention has been described as by a specific example and various embodiments, there is no intent to limit the inventive concept except as set forth in the following claims.

1. A process for preparing a carbon fiber precursor, the process comprising:
(a) obtaining a series of monomer mixtures;
(b) individually polymerizing the series of monomer mixtures in a polymerization unit;
(c) individually withdrawing from the polymerization unit a series of polymers obtained from each monomer mixture;
(d) individually forming spin dopes from the series of polymers;
(e) individually removing the spin dopes to a spinning unit and spinning each spin dope in the series;
(f) individually withdrawing from the spinning unit a series of gelled filaments;
(g) individually removing the series of gelled filaments to a first solvent extraction zone;
(h) individually withdrawing from the first solvent extraction zone a series of filaments;
(j) individually removing the series of filaments to a bundling zone;
(k) individually withdrawing from the bundling zone a series of fibers;
(l) individually removing the series of fibers to a second solvent extraction zone;
(m) individually withdrawing from the second solvent extraction zone a series of solid fibers;
(n) individually removing the series of solid fibers to a stretching zone and a relaxing zone;
(o) individually withdrawing from the stretching zone and the relaxing zone a series of solid PAN fibers;
(p) individually removing the series of solid PAN fibers to an analysis zone;
(q) individually analyzing the series of solid PAN fibers for a physical property which is a member selected from the group consisting of: number of surface defects, interior homogeneity, degree of orientation, tenacity, number and size of micro voids, arrangement of crystallites on the surface, compactness of structure, and combinations thereof to obtain a series of analysis results;
(r) ranking the series of solid PAN fibers based on the series of analysis results; and
(s) selecting the solid PAN fiber that is the most highly ranked, wherein the most highly ranked solid PAN fiber is employed as the carbon fiber precursor.

2. The process according to claim 1 wherein the series of monomer mixtures comprises acrylonitrile monomer and completely neutralized itaconic acid monomer.

3. The process according to claim 2 wherein the completely neutralized itaconic acid is neutralized with a base selected from the group consisting of ammonia, ammonium hydroxide, a low molecular weight primary amine, a low molecular weight secondary amine and mixtures thereof;

4. The process according to claim 2 wherein the acrylonitrile monomer is present in an amount of about 92 weight % to about 98 weight %, and the completely neutralized itaconic acid monomer is present in an amount of about 2 weight % to about 8 weight %.

5. A carbon fiber prepared from a mixture of monomers, wherein the mixture of monomers is obtained from a ranking of a series of solid PAN fibers, wherein the solid PAN fibers are obtained from a series of monomer mixtures, and wherein the series of monomer mixtures comprises acrylonitrile in an amount of about 92 weight % to about 98 weight % and completely neutralized itaconic acid in an amount of about 2 weight % to about 8 weight %.

6. The carbon fiber according to claim 5 wherein the ranking of the series of solid PAN fibers is based on a physical property which is a member selected from the group consisting of: number of surface defects, interior homogeneity, degree of orientation, tenacity, number and size of micro voids, arrangement of crystallites on the surface, compactness of structure, and combinations thereof.

7. An apparatus for preparing a carbon fiber precursor, the apparatus comprising:
(a) a neutralization zone for obtaining a completely neutralized itaconic acid, wherein a neutralizing agent is a member selected from the group consisting of ammonia, ammonium hydroxide, a C₁-C₆ alkyl primary amine and a C₁-C₆ dialkyl secondary amine;
(b) a polymerization zone for obtaining a solid PAN polymer, wherein an acrylonitrile monomer is polymerized with a completely neutralized itaconic acid monomer to obtain the PAN polymer;
(c) a first transfer means for removing the completely neutralized itaconic acid to the polymerization zone;
(d) a spin dope preparation zone for addition of an organic solvent to the PAN polymer to obtain a spin dope;
(e) a second transfer means for removing the PAN polymer to the spin dope preparation zone;
(f) a spinning zone for obtaining a gelled PAN filament;
(g) a third transfer means for removing the spin dope to the spinning zone;
(h) a solvent removal zone for solidifying the gelled PAN filament to obtain a solid PAN filament;
(k) a fourth transfer means for removing the gelled PAN filament to the solvent removal zone;
(l) a stretching zone for obtaining an elongated solid PAN filament;
(m) a fifth transfer means for removing the solid PAN filament to the stretching zone;
(n) a relaxation zone for obtaining a relaxed elongated solid PAN filament;
(o) a sixth transfer means for removing the elongated solid PAN filament to the relaxation zone;
(p) a bundling zone for obtaining a solid PAN fiber from a collection of relaxed elongated solid PAN filaments;
(q) a seventh transfer means for removing the relaxed elongated solid PAN filament to the bundling zone;
(r) an analysis zone for obtaining an analyzed solid PAN fiber; wherein the analysis zone includes measurement devices for obtaining a physical property of the solid PAN fiber, and wherein the physical property is a member selected from the group consisting of: number of surface defects, interior homogeneity, degree of orientation, tenacity, number and size of micro-voids, arrangement of crystallites on the surface of the fiber, compactness of structure and combinations thereof;
(s) an eighth transfer means for removing the solid PAN fiber to the analysis zone;
(t) a ranking zone for obtaining a ranked solid PAN fiber; and
(u) a ninth transfer means for removing the analyzed solid PAN fiber to the ranking zone, wherein the most highly ranked solid PAN fiber is employed as the carbon fiber precursor.

8. The apparatus according to claim 7 wherein the solid PAN polymer is prepared from a mixture of monomers, wherein the mixture of monomers comprises acrylonitrile in an amount of about 92 weight % to about 98 weight % and completely neutralized itaconic acid in an amount of about 8 weight % to about 2 weight %.

9. A mixture of monomers useful in preparing a carbon fiber precursor, wherein the mixture is from a series of monomer mixtures comprising acrylonitrile in an amount of about 92 weight % to about 98 weight % and completely neutralized itaconic acid in an amount of about 8 weight % to about 2 weight %; wherein the itaconic acid is neutralized with a base selected from the group consisting of ammonia, ammonium hydroxide, a low molecular weight primary amine, a low molecular weight secondary amine and mixtures thereof; wherein a series of solid PAN fibers is prepared from the series of monomer mixtures; wherein the series of solid PAN fibers is analyzed for a physical property which is a member selected from the group consisting of: number of surface defects, interior homogeneity, degree of orientation, tenacity, number and size of micro voids, arrangement of crystallites on the surface, compactness of structure, and combinations thereof to obtain a series of analysis results; wherein the series of solid PAN fibers is ranked based on the series of analysis results; and wherein the mixture of monomers yielding the most highly ranked solid PAN fiber is employed as a starting material for the preparation of the carbon fiber precursor.

10. The mixture of monomers according to claim 9 wherein the number of monomer mixtures in the series is a member selected from the group consisting of two monomer mixtures, three monomer mixtures, four monomer mixtures, five monomer mixtures, six monomer mixtures, seven monomer mixtures and eight monomer mixtures.

11. The mixture of monomers according to claim 10 wherein four monomer mixtures are: 2 weight % completely neutralized itaconic acid (98 weight % acrylonitrile), 4 weight % completely neutralized itaconic acid (96 weight % acrylonitrile), 6 weight % completely neutralized itaconic acid (94 weight % acrylonitrile), and 8 weight % completely neutralized itaconic acid (92 weight % acrylonitrile).
